(19) United States
(12) Patent Application Publication
(10) Pub. No.: US 2003/0216140 A1
(43) Pub. Date: Nov. 20, 2003

(54) Universal identification system for access points of wireless access networks

(76) Inventor: Georg Chambert, Uppsala (SE)

Correspondence Address: JENKENS & GILCHRIST, P.C., Suite 3200, 1445 Ross Avenue, Dallas, TX, 75202-2799, US

(21) Appl. No.: 10/150,039

(22) Filed: May 17, 2002

(51) Int. Cl. H04Q 7/20

(52) U.S. Cl. 455/426.1; 455/422.1

(57) ABSTRACT

A universal identification system is disclosed for uniquely identifying cells, or more generally, access points, within wireless access networks. The universal identification system uses a domain name system (DNS) name of the fully qualified domain system (FQDN) type for identification of access points. The system includes one or more Access Networks, each having one or more access points associated therewith. Each access point is assigned a unique DNS name of the FQDN type. A DNS server stores the FQDN namestring and a translation to an associated Internet Protocol (IP) address for the DNS name for routing purposes. The DNS FQDN identifier(s) can be broadcast for use in performing mobility procedures, such as location updates and handoffs, between Access Networks.

### BACKGROUND OF THE PRESENT INVENTION

1. Field of the Invention

The present invention relates generally to identification of nodes within a telecommunications system, and particularly to a universal identification system that uniquely identifies access points within a cellular (wireless) network.

2. Background of the Present Invention

Each network node within a cellular (wireless access) system is usually provided with a unique identity for routing of messages and performance of radio-related functions. In addition, each network node may service multiple geographical areas, each of which may have a separate identity associated therewith. For example, a cell, defined by a certain number of channels available to a particular geographical coverage area of an antenna, is typically assigned an identifier. In addition, a location area, containing one or more cells, is also typically assigned an identifier. The cell identifier and location area identifier can be broadcast to all mobile terminals within the geographical coverage area of the cell and/or location area for use by the mobile terminals in mobility procedures.

For example, the location area identifier can be used for location update procedures, while the cell identifier can be used for cell handoff procedures. In a location update process, the mobile terminal uses the broadcast location area identifier to determine whether the broadcast location area identifier is different from a location area to which the mobile terminal has registered and over which the mobile terminal can be paged. In a handoff process, the mobile terminal searches for candidate cells using the broadcast cell identifiers of the candidate cells, and when a suitable candidate cell is selected, the network uses the cell identifier of the selected candidate cell to contact the selected candidate cell for allocation of radio resources and preparation for the handoff.

However, cell identifiers and location area identifiers are primarily system specific solutions that are not particularly suited for use with multiple access systems in third generation cellular networks. Such third generation cellular networks allow network providers to offer different types of access protocols to mobile users. Specifically, third generation cellular networks logically divide the infrastructure into a Core Network and one or more Access Networks connected to the Core Network. The basic Core Network is constituted of circuit-switched nodes, such as Mobile Switching Centers (MSCs).

Each basic Access Network is constituted of radio control nodes and radio access nodes. As an example, the radio control nodes may be a Base Station Controller (BSC) for GSM (Global System for Mobile Communications) radio networks and a Radio Network Controller (RNC) for UMTS (Universal Mobile Telecommunications System) radio networks. As a further example, the radio access nodes may be a Base Transceiver Station (BTS) for GSM radio networks and a Node B for UMTS radio networks. Each of the radio access nodes can service one or more cells, and the geographical coverage area of the cell(s) served by one radio access node can overlap the geographical coverage area of the cell(s) served by another radio access node.

Identification of cells and location areas in a multi-access environment requires knowledge of each specific access network identifying scheme in order to perform location updates and handoffs between cells in different access networks. For example, in order for a mobile terminal to determine whether a location update needs to be performed, the mobile terminal must be able to determine which access network a particular location area identifier belongs to, thus requiring each addressing scheme to be explicitly listed and defined beforehand. In addition, when using private address ranges to build an Access Network, the network operator may have to provide private networking information in addition to the private address for the cell in order to perform handoffs between Access Networks. There exists a need for a universal identification system for interworking between Access Networks.

### SUMMARY OF THE INVENTION

The present invention provides a universal identification system for uniquely identifying cells and location areas, or more generally, access points, within wireless access networks. In one embodiment, the universal identification system uses a domain name system (DNS) name of the fully qualified domain system (FQDN) type for identification of access points. The system includes one or more Access Networks, each having one or more access points associated therewith. Each access point is assigned a unique DNS name of the FQDN type. The DNS FQDN identifier(s) of the access points are broadcast on an overhead channel of base stations within the Access Networks.

In further embodiments, a DNS server stores the FQDN namestring and a translation to an associated Internet Protocol (IP) address for the DNS name. Messages within the network are routed to/from access points by querying the DNS server with the FQDN namestring of a particular access point to determine the IP address of the particular access point for routing purposes.

In one implementation, the location area DNS FQDN identifier is broadcast on an overhead channel for use by mobile terminals in identifying the current location area and performing location updates. In another implementation, the cell DNS FQDN identifiers of serving cell and neighboring cells are broadcast on respective overhead channels of the cells for use by mobile terminals in identifying the cells and performing handoffs between the cells.

Advantageously, assigning a DNS FQDN identifier to each access point enables the identity of the access point to be the same regardless of the specific addressing scheme of the associated Access Network. In addition, using clear text naming at installation of base stations and relying on automatic mechanisms for resolving addressing for traffic routing based on the clear text naming reduces complexity when configuring the base stations. Furthermore, the invention provides embodiments with other features and advantages in addition to or in lieu of those discussed above. Many of these features and advantages are apparent from the description below with reference to the following drawings.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a block diagram illustrating an exemplary multi-access network architecture;

FIG. 2 is a functional block diagram illustrating an exemplary universal identification system for uniquely identifying access points within wireless access networks;

FIG. 3 is an exemplary table illustrating the mapping between domain name server (DNS) names and Internet Protocol (IP) addresses;

FIG. 4 is a functional block diagram illustrating one implementation of the universal identification system in accordance with exemplary embodiments of the present invention;

FIG. 5 illustrates the inclusion of a universal location area identity within a broadcast overhead channel in accordance with exemplary embodiments of the present invention;

FIG. 6 is a flowchart illustrating exemplary steps for performing a location update using the universal identification system of the present invention;

FIG. 7 is a flowchart illustrating exemplary steps for obtaining routing information using the universal identification system of the present invention;

FIG. 8 is a block diagram illustrating another implementation of the universal identification system in accordance with exemplary embodiments of the present invention;

FIG. 9 illustrates the inclusion of a universal cell identity within a broadcast overhead channel in accordance with exemplary embodiments of the present invention; and

FIG. 10 is a flow chart illustrating exemplary steps for performing a handoff procedure using the universal identification system of the present invention.

### DETAILED DESCRIPTION OF THE EXEMPLARY EMBODIMENTS

The numerous innovative teachings of the present application will be described with particular reference to the exemplary embodiments. However, it should be understood that this class of embodiments provides only a few examples of the many advantageous uses of the innovative teachings herein. In general, statements made in the specification do not necessarily delimit any of the various claimed inventions. Moreover, some statements may apply to some inventive features but not to others.

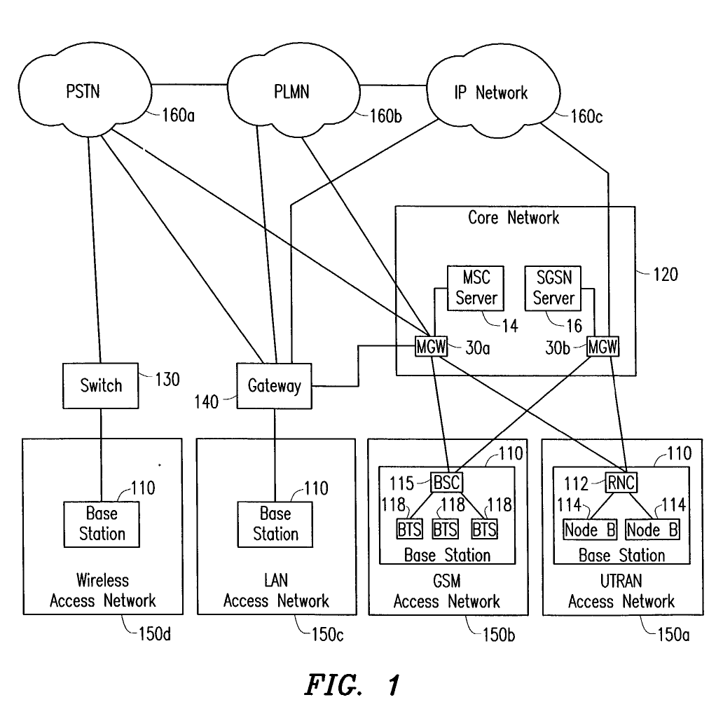

FIG. 1 illustrates an exemplary multi-access architecture, including both third generation access networks and traditional access networks. The third generation Access Networks, such as the Universal Terrestrial Radio Access Network (UTRAN) 150a or GSM network 150b, are connected to a Core Network 120. In the Core Network 120, the call control and connectivity are separated into different layers by removing the switching fabric from the MSC and placing the switching fabric in a Media Gateway (MGW) 30a. Thus, the MSC is divided internally, creating a MSC server 14 and a MGW 30a. In addition, for packet data services, the serving General Packet Radio Service (GPRS) support node (SGSN) is divided internally, creating a SGSN server 16 and a MGW 30b.

The MGWs 30a and 30b provide for interworking between the third generation Access Networks and the Core Network 120. For example, MGW 30a provides an interface for handling circuit-switched traffic between the Access Networks 150a and 150b and an external network, such as the Public Switched Telephone Network (PSTN) 160a or Public Land Mobile Network (PLMN) 160b. Likewise, MGW 30b provides an interface for handling packet-switched traffic between the Access Networks 150a and 150b and an external network, such as an Internet Protocol (IP) network 160c (e.g., the Internet or an Intranet).

Various traditional access networks are also shown in FIG. 1. For example, a local area network (LAN) Access Network 150c and a wireline Access Network 150d are both illustrated. The LAN Access Network 150c interconnects to all other external networks (e.g., IP network 160c, PSTN 160a, PLMN 160b and Core Network 120) via a Gateway 140 for converting between protocols used in the external networks and the protocols used in the LAN. The wireline Access Network 150d is connected to the PSTN 160a through a local switch 130.

Each Access Network 150a-d includes a base station 110 for providing both radio control and radio access functions. For example, in the GSM Access Network 150b, the base station 110 includes a Base Station Controller (BSC) 115 for handling of radio resources and one or more Base Transceiver Stations (BTSs) 118 for providing radio transmission in one or more cells (not shown). As another example, in the UTRAN Access Network 150a, the base station 110 includes a Radio Network Controller (RNC) 112 for handling of radio resources and one or more Node B's 114 for providing radio transmission in one or more cells.

Today, with the proper mobile equipment and service agreement, mobile subscribers are able to freely roam between Access Networks 150 provided by a network operator or between Access Networks 150 provided by different network operators that have operator agreements in place. For example, a mobile subscriber may have a subscription that enables access to both a LAN Access Network 150c while within the LAN area (e.g., while at work) and to a GSM Access Network 150b when outside of the LAN. As another example, a mobile subscriber may have a subscription that enables access to both a wireline Access Network 150d while within a restricted area (e.g., near their residence) and to a UTRAN Access Network 150a when outside of the restricted area.

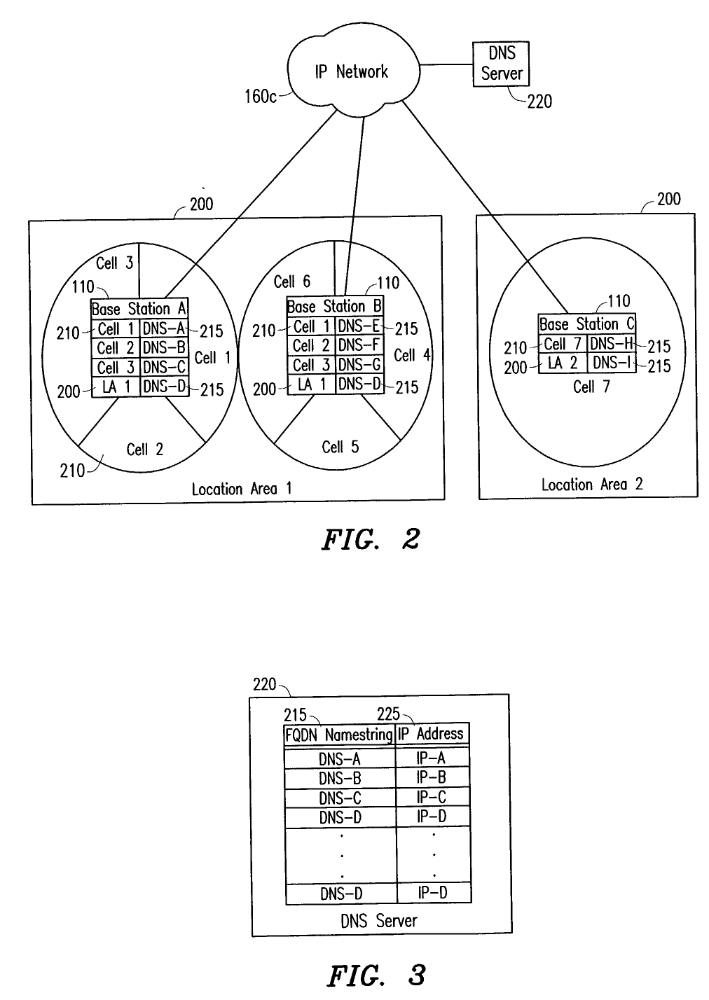

Referring now to FIG. 2, identification of access points, such as cells 210 and location areas 200, within the various Access Networks 150 (shown in FIG. 1) has traditionally been network specific, requiring each addressing scheme to be explicitly listed and defined beforehand. In accordance with exemplary embodiments of the present invention, to reduce complexity when addressing access points 200 and 210, a universal identification system can be used. For example, the access points 200 and 210 can be identified in terms of a fully qualified domain system (FQDN) namestring within the global domain name system (DNS) domain hierarchy. Therefore, the identification of the various access points 200 and 210 is the same regardless of the Access Network to which it belongs.

Each base station 110 shown in FIG. 2 serves one or more cells 210, and each of the cells 210 is associated with a particular location area 200. For example, Base Station A serves cell 1, cell 2 and cell 3, all of which are located within Location Area 1. Likewise, Base Station B serves cell 4, cell 5 and cell 6, all of which are also location within Location Area 1. It should be understood that not all cells 210 served by the same base station 110 need to be within the same location area 200. However, for simplicity, a single location area 200 is shown covering all cells 210 served by Base Stations A and B. Base station C serves only cell 7, which is located in Location Area 2.

Each cell 210 is assigned a DNS name 215 of the FQDN type and each location area 200 is also assigned a DNS name 215 of the FQDN type. For example, cells 1, 2 and 3 are assigned DNS-A, DNS-B and DNS-C, respectively, Location Area 1 is assigned DNS-D, cells 4, 5 and 6 are assigned DNS-E, DNS-F and DNS-G, respectively, cell 7 is assigned DNS-H and Location Area 2 is assigned DNS-I.

For various signaling and routing purposes, the base stations 110 and other network nodes (not shown) can connect, via an IP network 160c, to a DNS server 220 that stores the FQDN namestring 215 for each access point 200 and 210 along with a translation to an associated Internet Protocol (IP) address 225 for the DNS name 215, as is illustrated in FIG. 3. Upon initialization of each access point 200 or 210, the FQDN namestring 215 assigned to the access point 200 or 210 is registered in the DNS server 220, where an associated IP address 225 is determined and stored. For example, in a plug and play scenario, once a base station unit 110 has been attached to the network and assigned one or more DNS names 215 (for the cells 200 and location areas 210 it serves), the base station 110 can automatically register the FQDN namestrings 215 into the DNS server 220 by using available dynamic DNS signaling procedures, as is understood in the art.

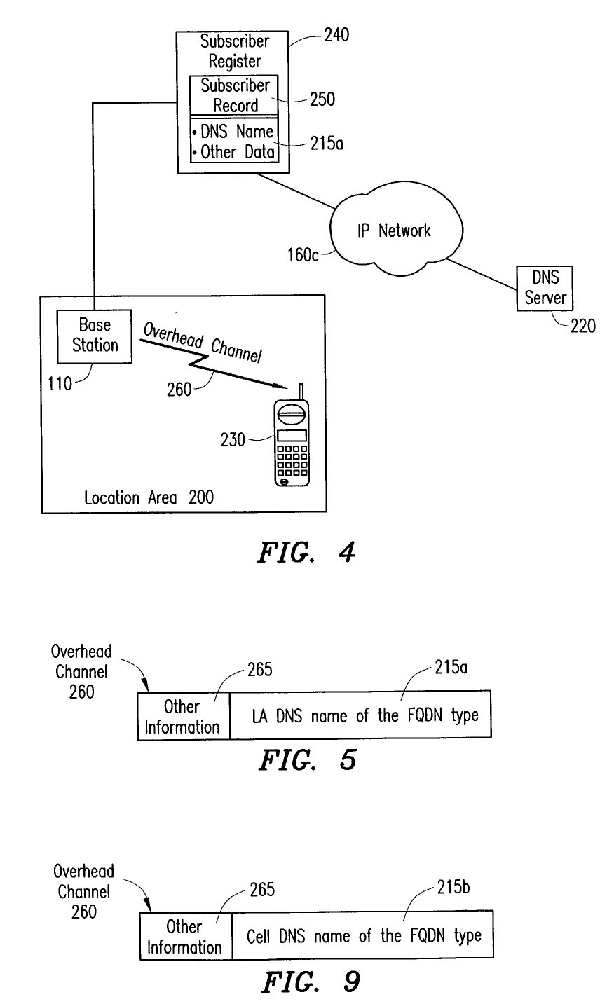

FIG. 4 illustrates one implementation of the universal identification system, in which the DNS FQDN identifier of a location area access point 200 is broadcast by the base station 110 on an overhead channel 260 for use by mobile terminals 230 in identifying the location area 200 and performing location updates. As shown in FIG. 5, the overhead channel 260 can include the location area DNS name of the FQDN type 215a, along with other information 265. For example, in GSM Access Networks, the overhead channel 260 is a broadcast control channel (BCCH) that includes cell information 265, such as the maximum output power for the cell, along with the location area identity (LAI) associated with the cell. Instead of the traditional LAI, in accordance with embodiments of the present invention, the DNS name 215a of the location area can be included in the BCCH.

The DNS name 215a of the current location area within which the mobile terminal 230 is located is stored in a subscriber record 250 within a subscriber register 240 (e.g., a Home Location Register or a distributed subscriber register), along with other subscriber data 255 associated with the mobile terminal 230. For call routing purposes, the subscriber register 240 can access the DNS server 220, via an IP network 160c, to convert the stored DNS name 215a to an IP address 225 (shown in FIG. 3) for the location area 200.

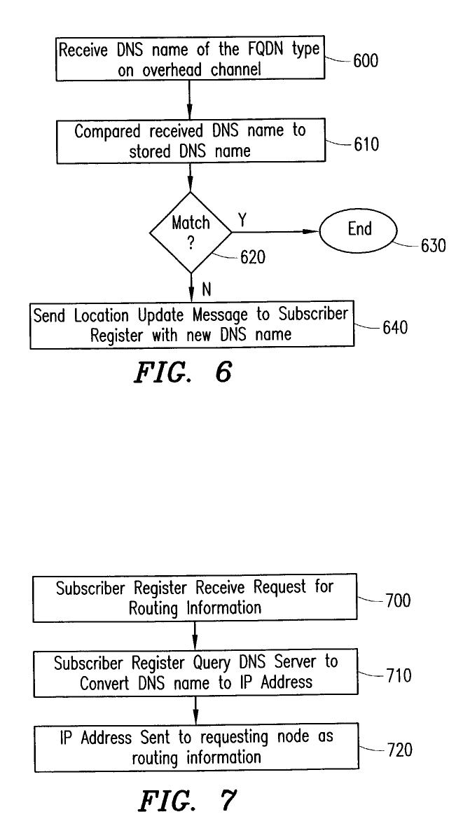

A sample location update procedure is described in FIG. 6. Each base station maintains the DNS name of the location area associated with each cell that the base station serves. Each cell broadcasts the DNS name of the location area containing the cell on the overhead channel. For example, the DNS name for a location area can have a form similar to the following: loc-1015-stockholm.telia.se.

Upon receipt of the location area DNS name (step 600), a mobile terminal compares the received DNS name to a stored DNS name of the location area that the mobile terminal previously registered with (step 610). If the received DNS name matches the stored DNS name (step 620), the mobile terminal has not roamed into a new location area, and no location update needs to be performed (step 630). However, if the received DNS name does not match the stored DNS name (step 620), the mobile terminal must register with the new location area by sending a location update message via the base station to the subscriber register with the new location area DNS name (step 640). For example, to register with location area “loc-1015.stockholm.telia.se”, the mobile terminal can send a location update message including the DNS name “loc-1015.stockholm.telia.se” .

As a result, a reference to the “loc-1015.stockholm.telia.se” is stored within the subscriber register. Thereafter, as shown in FIG. 7, when the subscriber register receives a request for routing information for the mobile terminal (e.g., there is an incoming call to the mobile terminal) (step 700), the subscriber register queries the DNS server for the IP address associated with the stored location area DNS name (step 710). The subscriber register passes this IP address back to the requesting entity (step 720), so that the incoming call can be properly routed towards the mobile terminal.

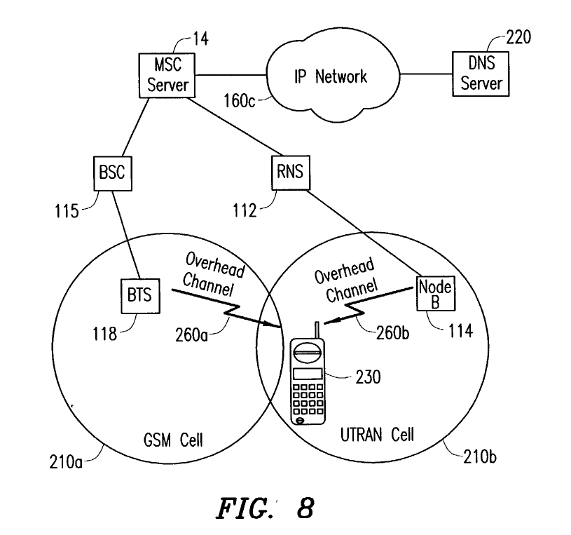

FIG. 8 illustrates another implementation of the universal identification system, in which the DNS FQDN identifier of cell access points 210a and 210b are broadcast by base stations on respective overhead channels 260a and 260b for use by a mobile terminal 230 in identifying the cells 210a and 210b and performing handoffs between the cells 210a and 210b. As shown in FIG. 9, the overhead channel 260 can include the cell DNS name of the FQDN type 215b, along with other information 265.

Handoffs are typically performed when a mobile terminal 230 roams into the area covered by a different cell (e.g., from cell 210a to 210b), or when traffic congestion in one cell (e.g. cell 210a) forces handoffs to other nearby cells (e.g., cell 210b). The cells 210a and 210b can be served by the same base station or different base stations, the latter being illustrated. In addition, the cells 210a and 210b can be associated with the same Access Network or different Access Networks, the latter being illustrated. For example, as shown in FIG. 8, a mobile terminal 230 has roamed from a cell 210a associated with a GSM Access Network into a cell 210b associated with a UTRAN Access Network. The mobile terminal 230 receives the cell DNS name of the GSM cell 210a from the overhead channel 260a broadcast by the BTS 118 and the cell DNS name of the UTRAN cell 210b from the overhead channel 260b broadcast by the Node B 114.

Since the cells 210a and 210b in FIG. 8 are associated with different Access Networks, the handoff requires the interaction of the radio control nodes (i.e., the BSC 115 and RNS 112) of the two Access Networks and the MSC server 14 serving both Access Networks. However, it should be understood that the two Access Networks could be served by separate MSC servers, requiring the interaction of both MSC servers to complete the handoff. To perform the various signaling required to complete the handoff, the DNS server 220 is contacted by the MSC server 14, via the IP network 160c, to determine the IP addresses associated with the DNS names of the two cells 210a and 210b.

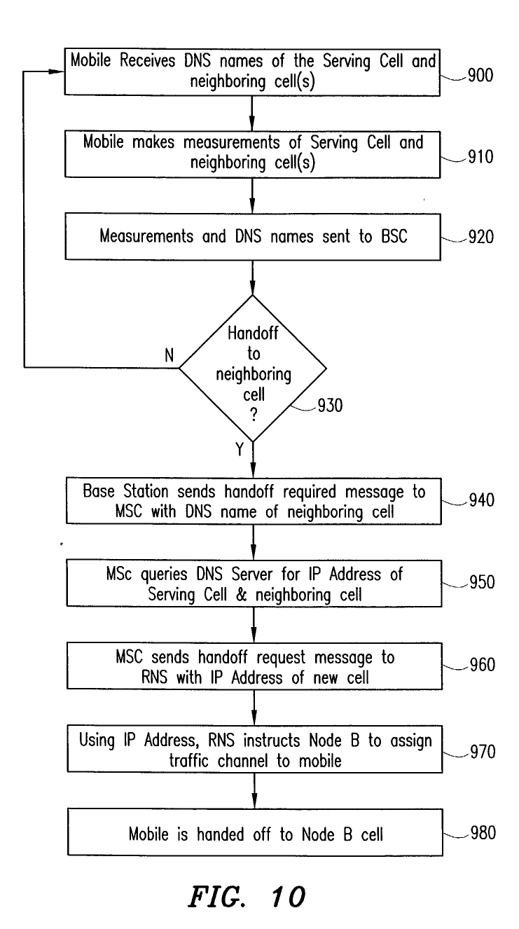

A sample handoff procedure for the scenario shown in FIG. 8 is described in FIG. 10. Each neighboring cell that is a candidate cell for the mobile terminal to perform a handoff to broadcasts a cell identifier of the FQDN type over the overhead channel for the cell (step 900). In addition, the mobile terminal continuously measures the signal strength and quality of both the serving cell and all potential candidate cells (step 910). The various measurements and associated DNS names are sent to the radio control node of the serving cell (e.g., in FIG. 8, the BSC) (step 920). If the BSC determines that one of the candidate cells can provide better signal strength and quality to the mobile terminal (step 930), a handoff to the selected candidate cell is performed. Otherwise, the mobile terminal continues to receive the DNS names of candidate cells and make measurements of those candidate cells (steps 900-920).

To perform the handoff, the BSC sends a handoff required message to the MSC server (step 940), and the MSC server queries the DNS server for the IP address of the selected candidate cell and the IP address of the serving cell (step 950). It should be understood that in other handoff scenarios where the MSC server is not involved, the base station (e.g., BSC) can send the query to the DNS server (via the MSC server). The IP addresses of the serving cell and the selected candidate cell are used for signaling purposes between the BTS and Node B nodes to perform the handoff.

For example, once the MSC server obtains the IP address of the selected candidate cell, the MSC server sends a handoff request message including the IP address of the selected candidate cell to the RNS (step 960). It should be noted that conventional network signaling is used between the RNS and the MSC server (this could be IP-based or any other addressing scheme and signaling protocol). However, the IP address of the selected candidate cell is used by the RNS to instruct the Node B associated with the IP address to assign a traffic channel to the mobile terminal (step 970). Once the traffic channel has been assigned, the mobile terminal can be handed off to the new Node B cell (step 980), using the IP address of the serving cell to send information to the mobile terminal regarding the assigned traffic channel in the new Node B cell.

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

What is claimed is:

1. A wireless telecommunications system for implementing a universal identification system, comprising:
an access network having one or more access points associated therewith, each of said access points being assigned a respective domain name system name of the fully qualified domain system type; and
a base station within said access network capable of broadcasting said domain name system name associated with at least one of said access points associated with said access network over at least part of a coverage area of said base station.

2. The telecommunications system of claim 1, wherein said access points include one or more cells served by said base station.

3. The telecommunications system of claim 2, wherein said access points include one or more location areas associated with said one or more cells.

4. The telecommunications system of claim 1, wherein said access network is a third generation access network.

5. The telecommunications system of claim 1, wherein said access network is a local area network access network.

6. The telecommunications system of claim 1, wherein said access network is a wireline access network.

7. The telecommunications system of claim 1, further comprising:
a domain name system server accessible to said base station via an internet protocol network and configured to store said respective domain name system names of said access points and a translation of said domain name system names into respective internet protocol addresses.

8. The telecommunications system of claim 1, wherein said base station is configured to broadcast said domain name system name over an overhead channel associated with said base station.

9. The telecommunications system of claim 1, wherein said base station includes a radio control node and a radio access node.

10. A method for utilizing a universal identification system for access points within a wireless telecommunications system, comprising:
providing an access network having one or more access points associated therewith;
assigning a respective domain name system name of the fully qualified domain system type to said access points; and
broadcasting said domain name system name associated with at least one of said access points associated with said access network over at least part of a coverage area of a base station within said access network.

11. The method of claim 10, wherein said access points include one or more cells served by said base station.

12. The method of claim 11, wherein said access points include one or more location areas associated with said one or more cells.

13. The method of claim 10, further comprising:
translating said domain name system names of said access points into respective internet protocol addresses; and
storing said domain name system names of said access points and said respective associated internet protocol addresses within a domain name system server.

14. The method of claim 10, wherein said step of broadcasting further comprises:
broadcasting said domain name system name over an overhead channel associated with said base station.

15. A method for implementing a universal identification system for location areas within a wireless telecommunications system, comprising:
assigning a domain name system name of the fully qualified domain system type to a location area within the wireless telecommunications system having a mobile terminal located therein; and
storing said domain name system name within a subscriber register associated with said mobile terminal for use in locating said mobile terminal.

16. The method of claim 15, further comprising:
querying a domain name system server storing said domain name system name of said location area and an associated internet protocol address for said internet protocol address of said location area.

17. The method of claim 16, further comprising:
receiving a request for routing information for said mobile terminal from a requesting node; and
providing said internet protocol address associated with said location area to said requesting node.

18. A method for implementing a universal identification system for location areas within a wireless telecommunications system, comprising:
receiving a domain name system name of the fully qualified domain system type of a location area within which a mobile terminal is located at said mobile terminal;
determining whether a location update should be performed based on said step of receiving;
if so, sending a location update message including said domain name system name of said location area from said mobile terminal.

19. The method of claim 18, wherein said step of receiving further comprises:
receiving said domain name system name within an overhead channel broadcast by a base station serving a cell that said mobile terminal is located within.

20. The method of claim 18, wherein said step of determining further comprises:
comparing said received domain name system name of said location area with a stored domain name system name of a previous location area; and
if said received domain name system name does not match said stored domain name system name, performing said step of sending.

21. A method for implementing a universal identification system for cells within a wireless telecommunications system, comprising:
receiving a domain name system name of the fully qualified domain system type of a serving cell within which a mobile terminal is located at said mobile terminal;
receiving a domain name system name of the fully qualified domain system type of at least one candidate cell at said mobile terminal;
performing measurements associated with said serving cell and said candidate cell at said mobile terminal; and
transmitting said domain name system names of said serving cell and said candidate cell and said measurements to a network node in wireless communication with said mobile terminal for use in performing a handoff of communications from said serving cell to said candidate cell.

22. The method of claim 21, wherein said serving cell is associated with a first access network having a first access protocol type associated therewith and said candidate cell is associated with a second access network having a second access protocol type associated therewith.

23. The method of claim 21, wherein said steps of receiving further comprise:
receiving said domain name system names of said serving cell and said candidate cell within respective overhead channels broadcast by respective base stations serving said serving cell and said candidate cell.

24. A method for implementing a universal identification system for cells within a wireless telecommunications system, comprising:
broadcasting a domain name system name of the fully qualified domain system type of a serving cell within a coverage area of said serving cell;
receiving a domain name system of the fully qualified domain system type of a candidate cell and measurements associated with said serving cell and said candidate cell at a base station associated with said serving cell; and
querying a domain name system server storing said domain name system names of said serving cell and said candidate cell and respective associated internet protocol addresses for said serving cell and said candidate cell via an internet protocol network for said internet protocol addresses of said serving cell and said candidate cell to perform a handoff procedure involving said serving cell and said candidate cell.

25. The method of claim 24, wherein said step of broadcasting further comprises:
broadcasting said domain name system name within an overhead channel of said serving cell.

26. The method of claim 24, wherein said serving cell is associated with a first access network having a first access protocol type associated therewith and said candidate cell is associated with a second access network having a second access protocol type associated therewith.

27. The method of claim 24, wherein said step of querying is performed by a mobile switching center node serving said base station.

28. The method of claim 24, wherein said step of querying is performed by said base station.

29. The method of claim 24, further comprising:
using said internet protocol addresses of said serving cell and said candidate cell to route signaling messages to said base station associated with said serving cell and an additional base station associated with said candidate cell in order to perform said handoff procedure.

30. A subscriber register associated with a wireless telecommunications system, comprising:
a subscriber record containing subscriber data associated with a mobile terminal within said wireless within said wireless telecommunications system; and
means for storing a domain name system name of the fully qualified domain system type within said subscriber register for use in locating said mobile terminal, said domain name system name being assigned to a location area within said telecommunications system, said mobile terminal being located within said location area.

31. The subscriber register of claim 30, further comprising:
means for communicating with a domain name system server storing said domain name system name of said location area and an associated internet protocol address to retrieve said internet protocol address for said location area.

32. The subscriber register of claim 31, further comprising:
means for receiving a request for routing information for said mobile terminal from a requesting node; and
means for providing said internet protocol address associated with said location area to said requesting node.

33. The subscriber register of claim 30, further comprising:
means for receiving a location update message including said domain name system name of said location area from said mobile terminal.
